(19) United States
(12) Patent Application Publication
(10) Pub. No.: US 2005/0052045 A1
(43) Pub. Date: Mar. 10, 2005

(54) Vehicle side storage box

(76) Inventor: Robert Juzwiak, Plymouth, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/802,399

(22) Filed: Mar. 17, 2004

Related U.S. Application Data
(63) Continuation of application No. PCT/US02/29440, filed on Sep. 17, 2002.
(60) Provisional application No. 60/322,792, filed on Sep. 17, 2001.

(51) Int. Cl. B60R 9/06

(52) U.S. Cl. 296/37.6

(57) ABSTRACT

A side storage box for a motorized vehicle, comprising a plastic molded load body having storage compartments formed on an exterior wall before, behind and above a wheel well opening. The outer fender is configured to enclose the storage compartments and an articulating means is used for translating the outer fender substantially vertically to allow access to said compartments.

### CROSS REFERENCE TO RELATED APPLICATIONS

This application is a continuation of International Application No. PCT/US02/29440 filed Sep. 17, 2002 and published Mar. 27, 2003 as International Publication No. WO 03/024743, designating the United States, and which claims benefit of U.S. Provisional Application No. 60/322,792 filed Sep. 17, 2001.

### FIELD OF INVENTION

The present invention relates to a storage area built into the side of a pickup truck bed which is accessed by articulation of the truck fender outer wall. The storage area contains a series of storage compartments configured to store a variety of tools above, before and behind the rear wheel well area.

### BACKGROUND OF INVENTION

Pickup truck owners have used various containers to store and secure valuable items, such as tools and power equipment. Most common a toolbox that is placed across the width of the pickup bed immediately behind the cab. However, these boxes are difficult to access from the outside of the truck and also take up valuable space in the pickup bed. Other storage arrangements that may use the fender well area of the bed consist of complex assemblies of many metal components and have generally been hinged at the top for access. Thus, as they are opened, they take up a lot of space towards the outside of the vehicle. In addition, since they protrude outwardly at the top of the pickup bed body, they make access to the storage areas somewhat difficult and present a head-hitting hazard for workers. U.S. Pat. No. 6,237,211 B1 to Clare discloses a method of fabricating a hidden storage system incorporated in the bed of a vehicle without altering the bed's external appearance of various contours thereof, without revealing the storage system, by the assembly of modules containing various individual components. The storage system is located adjacent the wheel well sections of the bed and uses hinges to open and close fender/side panels of the bed. Components are assembled to form a floor assembly module, a tailgate assembly module, two vertically extending structural support assembly modules, and two side storage/panel assembly modules. Assembling of the components into modules includes hinging of at least one section of at least one side panel, at least one of the side storage/side panel modules to move outwardly.

U.S. Pat. No. 6,012,754, also to Clare, is more focused on the hidden aspects of storage and the methods used. It discloses a system which is composed of a storage box, a hinged side panel and a lock and latch mechanism. The storage box assembly is composed of numerous panels; side, wheelhouse, floor, front, door, etc.

U.S. Pat. No. 6,030,018, also to Clare, discloses hinged side panels on either the inside or outside of the pickup bed.

U.S. Pat. No. 6,170,723 B1 to Howell discloses a double-opening lid for use in a storage box in a pickup bed.

U.S. Pat. No. 6,102,474 to Daley discloses a pair of spaced inner vertically extending side walls affixed to lateral edges of a load bed. In this case, the outer wall is hinged at the top and can be pivoted to a lower position and a raised position.

U.S. Pat. No. 6,129,401 to Neag discloses a storage container assembly for deployment either within or adjacent to an external surface panel of a pickup truck which can be pushed, pulled or rotated from a closed position.

U.S. Pat. No. 6,059,341 to Jensen, et al. discloses a side panel that hinges about its lower point downwardly to expose a side storage compartment and latch.

U.S. Pat. No. 5,535,931 to Barlow, et al. discloses a storage system which straddles the rear wheel well of the pickup truck and can be accessed in an upright position over the wheel well or can be pivoted downward to form a storage area taking up a portion of the pickup bed.

U.S. Pat. No. 5,303,969 to Simnacher discloses a storage device for the bed of a pickup truck which is contained within the bed and which can be lifted by a mechanism to allow access from outside the vehicle. Like the previous reference, this container also straddles the wheel well but is articulated upward for access rather than pivoted into the body of the pickup bed.

U.S. Pat. No. 4,917,430 to Lawrence discloses a series of drawers accessible at the outside of the vehicle which are located behind the passenger side or driver's side door and in front of the pickup bed.

Similarly, U.S. Pat. No. 4,789,195 to Fletcher discloses a series of drawers which are accessible rearwardly from the back of the pickup truck near the tailgate, again using some of the storage area rearward of the fender well as storage bins.

U.S. Pat. No. 3,727,971 to Sisler discloses receptacle units for location entirely within a pickup box to effectively utilize the space. These units may be filled with particulate weight material for increased wheel traction or may contain fluids such as waster, gasoline or the like.

All of these references have the disadvantage of being comprised of multiple components and assemblies, and most hinge, which takes up additional space outside of the body of the vehicle which might be a working space and which interfere with easy access to the compartments. In addition, most take up some valuable space from within the pickup bed.

It is also known in the art to form pickup truck bodies of composite materials such as fiberglass reinforced plastic or reinforced or structural reaction injection molded plastic (RRIM, SRIM) in order to reduce weight and simplify the assembly process, substantially reducing part count. Fastening means may be integrated into the plastic molded structure. Johnson, et al. in U.S. Pat. No. 5,228,742 and Gentle in U.S. Pat. No. 4.976,490 both make reference to these product applications.

In neither of these cases, is it anticipated that the area between the inner and outer walls around the wheel wells would be used for storage or that such storage would be accessed by articulating the outer fender wall.

### SUMMARY OF THE INVENTION

The present invention relates to providing storage in a pickup truck body in areas that are normally hollow and unused, that is, the area between the fender outer skin and the inner pickup body bed (in other words, above, before and behind the wheel well). The invention contemplates a series of geometric storage areas configured to store a variety of tools, yielding the advantage of additional space, easy access and privacy. The storage space may be enclosed by the outer fender. The outer fender preferably may be translated upward or downward in a substantially vertical plane. The storage areas are thus out of sight, but can be easily locked for security. Preferably, the pickup body would be of unitary construction, molded of plastic/composite (fiberglass reinforced plastic, RRIM/SRIM, or fiber reinforced thermoplastic using such processes as resin transfer molding, laminating, thermoforming, blow-molding, injection molding, or compression molding). This provides a lightweight, durable construction which can be easily formed into the shapes of the compartments and requires minimal assembly. Thus, it can be adapted to OEM requirements and not just used as an aftermarket application. As can clearly be appreciated from the above, since the entire outer sidewall of the pickup body is being translated upward rather than being hinged outward, access is improved and the amount of space taken up around the truck is reduced. Further, the outer class A surface is retained as a single unbroken surface, maintaining aesthetic appearance.

It is therefore the basic object of the present invention to provide a pickup truck bed which is comprised of a minimum number of components, yet having a series of storage compartments in the body side wall, in front of, above and behind the wheel opening, with an outer cover which translates generally upward rather than being pivoted outward to allow easy access to the compartments.

It is a further object of the invention that the storage compartments be molded into shapes that approximate certain tools (drills, saws, wrenches) making for orderly location, reducing rattles and improving the unsightly appearance of the pickup bed.

It is further object of the invention to provide a pickup truck bed that provides more efficient use of space in the bed as well as around the bed outer periphery.

It is further object of the invention to provide improved access to the storage compartments by articulating the outer fender up and out of the way for users.

It is further object of the invention to provide substantially reduced weight and greatly reduced assembly due to the substantially plastic construction of the pickup bed. In addition, the outer fender may be molded of plastic to further improve durability and reduce weight.

It is a further object of the invention to provide a side storage box for a motor vehicle comprising a plastic molded load body having storage compartments formed on an exterior wall before, behind and above a wheel well opening, an outer fender configured to enclose the storage compartments, and an articulating means for translating the outer fender substantially vertically to allow access to said compartments.

It is further object of the invention to provide a side storage container for a motor vehicle comprising a plastic molded load body having storage compartments formed on an exterior wall juxtaposed a wheel well opening, an outer fender configured to enclose the storage compartments, and an articulating mechanism configured to translate the outer fender from a closed position to an open position to allow access to the compartments, the articulating mechanism maintaining the outer fender in a substantially vertical orientation.

### BRIEF DESCRIPTION OF THE DRAWINGS

These and other objects, features and advantages of the invention will become apparent upon consideration of the description of the invention and the appended drawing in which:

FIG. 1 is a representative perspective view of a pickup truck bed showing the outer fender in partially raised position; and

FIGS. 2A, 2B and 2C are rear perspective views of a pickup truck showing movement of an outer fender from a “closed” position to an “open” position.

The above other objects, features and advantages of the present invention will be apparent in the following detailed description thereof when read in conjunction with the appended drawing wherein the same reference characters denote the same or similar paths throughout the several views.

### DETAILED DESCRIPTION OF THE INVENTION

For elements common to the various embodiments of the invention, the numerical reference character between the embodiments is held constant, but distinguished by the addition of an alphanumeric character to the existing numerical reference character. In other words, for example, an element referenced at 10 in the first embodiment is corresponding referenced at 10A, 10B, and so forth in subsequent embodiments. Thus, wherein an embodiment description uses a reference character to refer to an element, the reference character applies equally, as distinguished by alphanumeric character, to the other embodiments where the element is common.

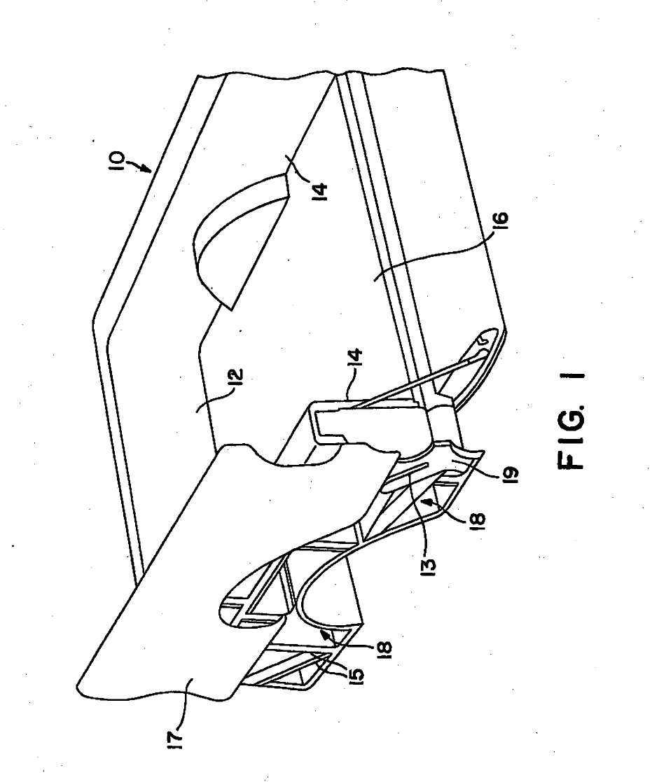

Referring to FIG. 1, there is shown a pickup bed 10 for a pickup truck, the bed may comprise an essentially unitary plastic body having a front wall 12, side walls 14 and a floor 16. The front wall 12, the side walls 14, and the floor 16 may form a bed liner. Modern plastic molding methods have evolved to where large moldings of this size can be accomplished by a variety of processes. The bed 10 may also be formed as separate walls and a floor then attached together by methods known to those skilled in the art, or the entire bed can be molded as a single body. Using hand lay-up, vacuum bag molding, or resin transfer processes, a glass reinforced plastic construction of lightweight and excellent physical properties can be obtained. In addition, new larger equipment is allowing parts of this size to be molded by compression, injection, thermoforming and blow molding processes. By adding reinforcing members to the molding, additional rigidity can be designed-in where needed. These reinforcing members can then be used as attachment points for anchoring the bed to the vehicle frame.

Turning again to FIG. 1, storage compartments 18 may be molded into the outer side wall 14 of the bed inner. The compartments may be molded to form shapes conducive to the storage of specific tools (skill saw, drill, wrenches, etc.) by having recessed portions matching the shapes of those tools. The storage compartments may be separated by a plurality of dividers 15. In addition, the dividers 15 that form the various compartments may also serve as reinforcing struts for the pickup bed. A fender outer 17 is shown in a partially raised position from its normally closed position covering the storage compartment 18. The fender outer 17 can be of sheet metal, but preferably is molded of plastic by the aforementioned processes, to provide an outer lighter in weight and more resistant to denting than a metal outer.

One embodiment of an articulating mechanism is shown in FIG. 1 as a pivot mechanism 19 and arm mechanism 13 which is attached to the back side of the fender outer 17 at a second hinge point. Mechanisms of this type are well know to those skilled in the art as they are commonly used on aircraft doors, passenger shuttle bus doors, and commercial bus luggage storage doors. They are generally comprised of two separate hinges connected by a rod mechanism which is formed at such an angle to allow the door, or in the case of the invention, the outer fender, to move slightly outwardly to clear the sealing edge, then move in a plane parallel with the doors' (fenders) closed position. Typically two mechanisms are used, one at each end of the door (fender). Examples of such preferred mechanisms as applied herein can be found in U.S. Pat. No. 4,479,622 and U.S. Pat. No. 6,030,024, and are herein incorporated by reference.

Alternatively, a mechanism commonly used on minivan “sliding” doors may be used. A pair of spaced, parallel tracks guide the fender outer substantially parallel to the side of the vehicle. Examples of such preferred mechanisms as applied herein can be found in U.S. Pat. No. 4,561,690 and U.S. Pat. No. 6,213,535 and are herein incorporated by reference.

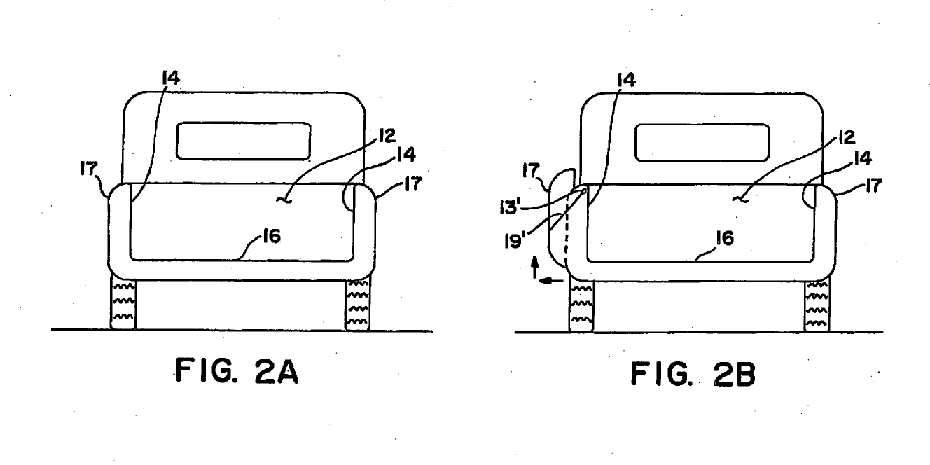

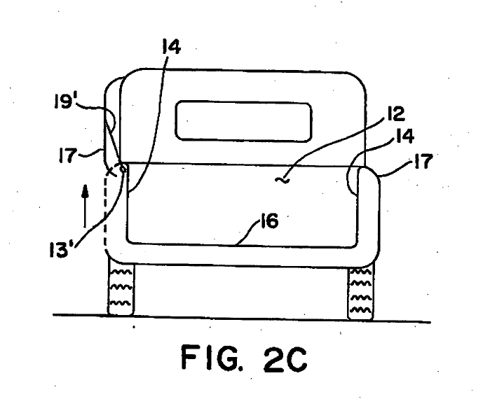

FIGS. 2A-C show a fender outer 17 in a “closed” position (FIG. 2A) in which there is no access to the storage compartments 18, an “intermediate” position (FIG. 2B), and an “open” position (FIG. 2C) in which there is access to the storage compartment 18. The articulating mechanism maintains the outer fender 17 in a substantially vertical orientation as the outer fender 17 moves from the “closed” position to the “open” position.

The description and drawings illustratively set forth my presently preferred invention embodiments. I intend the description and drawings to describe embodiments and not to limit the scope of the invention. Those skilled in the art will appreciate that still other modifications and variations of the present invention are possible in light of the above teaching while remaining within the scope of the following claims. Therefore, within the scope of the claims, one may practice the invention otherwise than as the description and drawings specifically show and describe.

1. A side storage box for a motorized vehicle, comprising:
a plastic molded load body having storage compartments (18) formed on an exterior wall before, behind and above a wheel well opening;
an outer fender (17) configured to enclose the storage compartments; and
an articulating means (13, 19) for translating the outer fender substantially vertically to allow access to said compartments.

2. The side storage box of claim 1, wherein said outer fender is molded of plastic.

3. The side storage box of claim 1, wherein said load body is molded by a process selected from the group consisting of resin transfer molding, reaction injection molding, laminating, thermoforming, injection molding, blow molding and compression molding.

4. The side storage box of claim 1, further comprising a locking mechanism to secure said outer fender in an open or closed position.

5. The side storage box of claim 1, wherein the articulating means translates the outer fender from a closed position to an open position to allow access to the compartments, the articulating means maintaining the outer fender in a substantially vertical orientation.

6. A side storage box for a motor vehicle, comprising:
a plastic molded load body having storage compartments (18) formed on an exterior wall juxtaposed a wheel well opening;
an outer fender (17) configured to enclose the storage compartments; and
an articulating mechanism (13, 19) configured to translate the outer fender from a closed position to an open position to allow access to the compartments, the articulating mechanism maintaining the outer fender in a substantially vertical orientation.

7. The side storage box of claim 6, wherein said outer fender is molded of plastic.

8. The side storage box of claim 6, wherein said load body is molded by a process selected from the group consisting of resin transfer molding, reaction injection molding, laminating, thermoforming, injection molding, blow molding and compression molding.

9. The side storage box of claim 6, further comprising a locking mechanism to secure said fender in an open or closed position.
